(19) United States
(12) Patent Application Publication
(10) Pub. No.: US 2016/0179352 A1
(43) Pub. Date: Jun. 23, 2016

(54) INFORMATION PROCESSING APPARATUS, COMPUTER-READABLE RECORDING MEDIUM STORING DISPLAY CONTROL PROGRAM, AND DISPLAY CONTROL METHOD

(71) Applicant: FUJITSU LIMITED, Kawasaki-shi (JP)

(72) Inventor: Kosuke Shiraishi, Shiki (JP)

(73) Assignee: FUJITSU LIMITED, Kawasaki-shi (JP)

(21) Appl. No.: 15/055,175

(22) Filed: Feb. 26, 2016

Related U.S. Application Data
(63) Continuation of application No. PCT/JP2013/073345, filed on Aug. 30, 2013.

(51) Int. Cl. G06F 3/0484; G06F 3/0488; G06F 3/01; G06F 3/038

(52) U.S. Cl. CPC G06F 3/04845; G06F 3/038; G06F 3/0488; G06F 3/04842; G06F 3/017

(57) ABSTRACT

An information processing apparatus includes a plurality of input tools, a first storage that stores pieces of object display format information, the pieces of object display format information relating pieces of display format information in a plurality of types to a graphical user interface (GUI) object, a detector that detects a change of an input tool of the input tools, and a display controller that selects a corresponding piece of object display format information for the GUI object according to the input tool after the detected change, and causes the GUI object to be displayed using the selected object display format information.

### CROSS-REFERENCE TO RELATED APPLICATION

This application is a continuation application of International Application PCT/JP2013/73345, filed on Aug. 30, 2013 and designated the U.S., the entire contents of which are incorporated herein by reference.

### FIELD

The embodiment discussed herein is directed to an information processing apparatus, a computer-readable recording medium storing a display control program, and a display control method.

### BACKGROUND

An operating system (OS) operating on a computer provided with a touch panel can be operated with input operations that are made by touching the screen with a finger or a thumb (touch input operations), as well as conventional input operations by means of a mouse. An OS operating on a computer provided with a motion sensor can be operated with input operations by moving an object in the three-dimensional space (motion input operations), without using any input tools, such as a mouse and without touches on screen.

These input operations by means of a mouse, a touch panel, and a motion sensor have inherent advantages and disadvantages as follows, for example. With mouse input operations where a pointer on a screen is moved for operating graphical user interface (GUI) objects (hereinafter, simply referred to as “objects”), such as buttons, although a satisfactory accuracy of operating smaller objects can be achieved, the number of user operations tends to be increased. With touch input operations where objects on a touch panel are directly operated by a finger or a thumb, although drastic operations, e.g., gestures with two or more of fingers and/or thumbs, can be quickly made, smaller objects are difficult to be operated. With motion input operations where objects are operated with movements of a hand or gestures by a finger or thumb, drastic operations can be quickly made, like touch input operations. However, although operations can be enabled or disabled by making clicks during a mouse input operation or taps during a touch input operation, no such enabling/disabling is available for motion input operations.

As described above, since the input tools in different types have the inherent advantages and disadvantages, optimum types, shapes, positions of objects are different for different input tools.

For those reasons, techniques are known for designing GUIs suited for only one of input tools provided for a computer.

Patent Document 1: Japanese Laid-open Patent Publication No. 11-95971

Patent Document 2: Japanese Laid-open Patent Publication No. 8-16353

Patent Document 3: Japanese Laid-open Patent Publication No. 11-282597

Patent Document 4: Japanese Laid-open Patent Publication No. 2011-138185

Patent Document 5: Japanese Laid-open Patent Publication No. 2010-257495

However, in environments where multiple input tools are available, users may select appropriate one of input tools, depending on the preferences of the users and/or the contexts. For example, one user may not employ mouse input operations in a GUI application, but another user may employ both mouse input operations and touch input operations in that same GUI application. Or, a user may select appropriate one of input tools depending on the contexts, such as the user uses touch input operations outside the office or home, but uses mouse input operations at home, for example. Or, a user may make multiple input operations simultaneously, such as touching a screen while operating a mouse.

There is a problem in that effective input operations may not be available depending on an input tool that is being used, when fixed types, shapes, and positions are used for objects in a GUI application.

### SUMMARY

The information processing apparatus includes a plurality of input tools, a first storage that stores pieces of object display format information, the pieces of object display format information relating pieces of display format information in a plurality of types to a graphical the user interface (GUI) object, a detector that detects a change of an input tool of the input tools, and a display controller that selects a corresponding piece of object display format information for the GUI object according to the input tool after the detected change, and causes the GUI object to be displayed using the selected object display format information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a function configuration of an information processing system as an example of an embodiment;

FIG. 2 is a diagram exemplifying display format information included in object display format information, in the information processing apparatus as an example of an embodiment;

FIG. 3 is a diagram exemplifying transition pattern display format information included in the object display format information, in the information processing apparatus as an example of an embodiment;

FIG. 4 is a diagram exemplifying input history information in the information processing apparatus as an example of an embodiment;

FIG. 5 is a diagram illustrating transitions among input mode states of GUI objects, in the information processing apparatus as an example of an embodiment;

FIG. 6 is a diagram illustrating an exemplary display of GUI objects, in the information processing apparatus as an example of an embodiment;

FIG. 7 is a diagram illustrating an exemplary display of a GUI application, in the information process ing apparatus as an example of an embodiment;

FIG. 8 is a diagram illustrating hit regions in the GUI application, in the information processing apparatus as an example of an embodiment;

FIG. 9 is a diagram illustrating a mode change region in the GUI application in the mouse mode and in the touch mode, in the information processing apparatus as an example of an embodiment;

FIG. 10 is a diagram illustrating a mode change region in the GUI application in the motion mode, in the information processing apparatus as an example of an embodiment;

FIG. 11 is a flowchart indicating input mode control processing, in the information processing apparatus as an example of an embodiment; and

FIG. 12 is a flowchart indicating input mode switching processing, in the information processing apparatus as an example of an embodiment.

### DESCRIPTION OF EMBODIMENTS

Hereinafter, one embodiment of an information processing apparatus, a display control program, and a display control method will be described with reference to the drawings. Note that the embodiment described below is merely exemplary and it is not intended that various modifications and applications of the technique which are not explicitly stated, are excluded. In other words, the present embodiment may be practiced in various modifications in the extent not departing from the spirit thereof.

The drawings are not intended to include only elements depicted, and additional functions and the like may also be included.

In the drawings, same reference symbols refer to similar elements, and their descriptions will be omitted.

(A) System Configuration

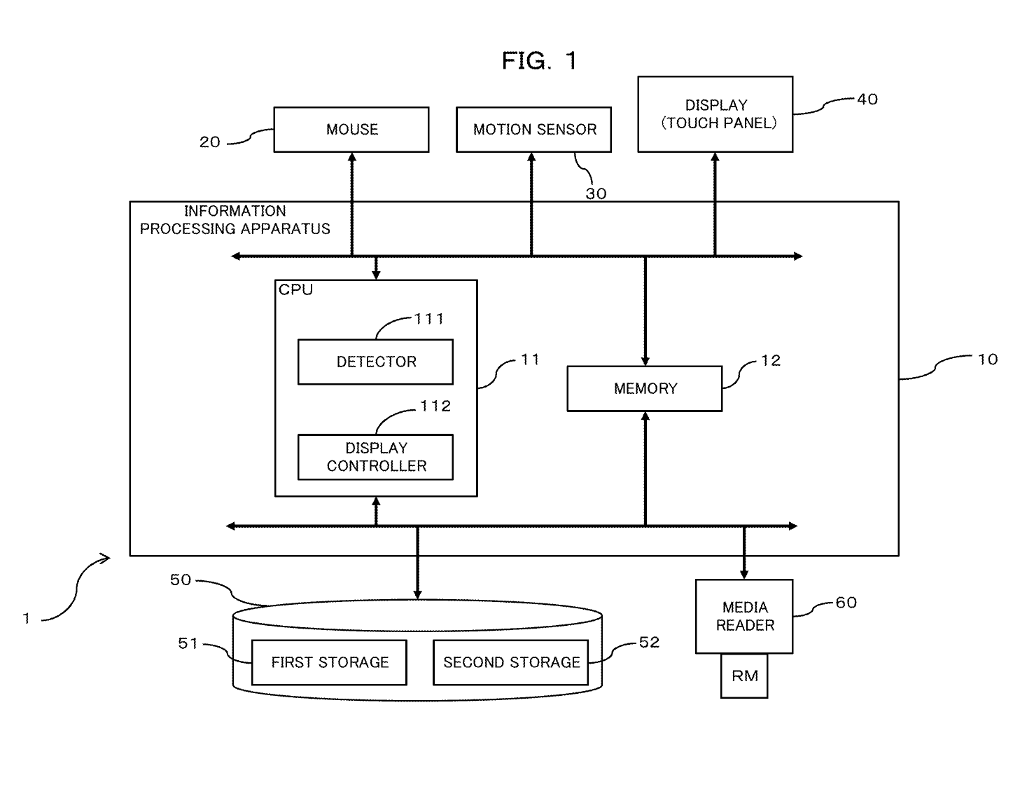

FIG. 1 is a diagram schematically illustrating a function configuration of an information processing system as an example of an embodiment.

As depicted in FIG. 1, an information processing system 1 as an example of the present embodiment includes an information processing apparatus 10, a mouse (pointing device) 20, a motion sensor 30, a display (touch panel) 40, a storage device 50, and a media reader 60. The information processing apparatus 10 is communicatively connected to the mouse 20, the motion sensor 30, the display 40, the storage device 50, and the media reader 60, as illustrated.

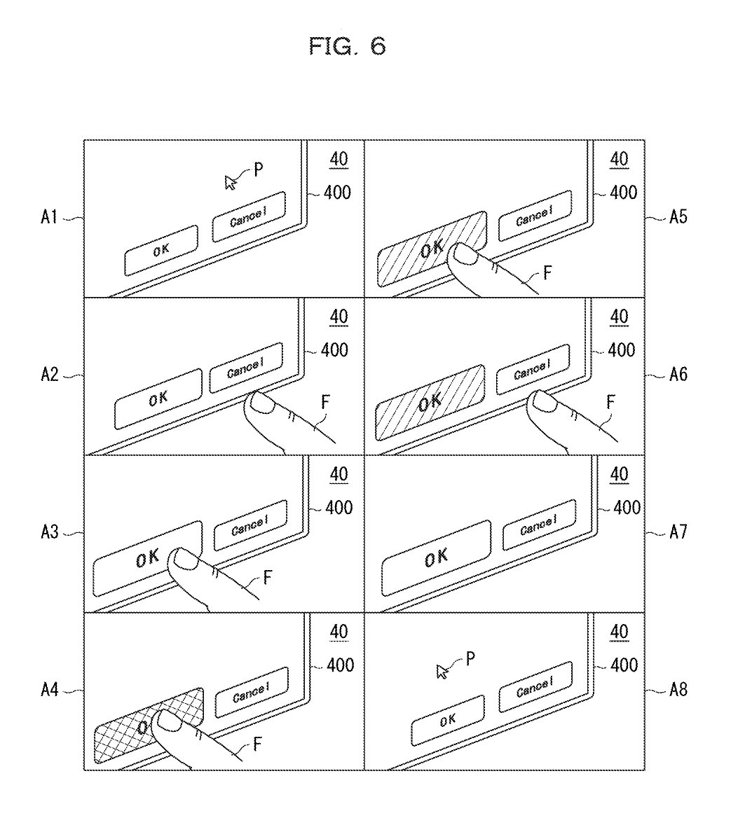

The mouse 20 represents an example of an input tool, and functions as a pointing device input tool in an example of the present embodiment, used for operating a pointer displayed on the display 40 (refer to the reference symbol P in A1 in FIG. 6). Note that the mouse 20 is merely an example of a pointing device, and a touch pad, such as those provided in a notebook personal computer or the like, or a trackball may be used as a pointing device.

The motion sensor 30 represents an example of an input tool, functions as a motion input tool in an example of the present embodiment, and measures movements made by a user for determining as input operations. The motion sensor 30 is a photo detector, an infrared detector, or a camera, for example, and is a detector that can detect positional information of an object in the three-dimensional space. The motion sensor 30 preferably has a resolution that is comparable to or greater than resolution of the display 40. Any detector that can obtain the coordinates in the three-dimensional space in front of the screen of the display 40 may be used as the motion sensor 30. Note that an acceleration sensor or emitter attached to a user's hand may be used as the motion sensor 30.

The touch panel 40 represents an example of an input tool, and functions as a touch input tool in an example of the present embodiment. The touch panel 40 is a device integrating an input device and a display device, and passes, to the information processing apparatus 10, information, e.g., a position, or an instruction touch-inputted by the user on the touch panel 40, and displays various types of information to the user or the like. Note that various techniques, such as an electrostatic capacitance or pressure-sensing techniques, may be applied as a sensing technique for the touch panel 40.

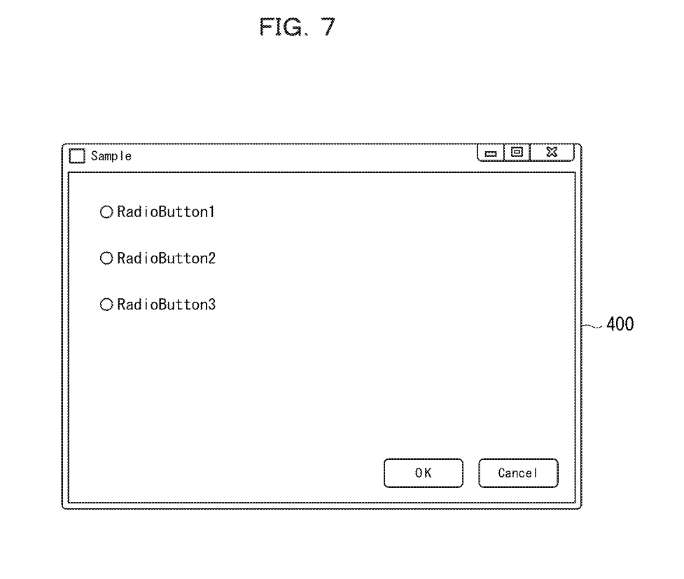

The user can switch an active input tool among the mouse 20, the motion sensor 30, and the touch panel 40 representing multiple input tools, according to the user's own preference, the context, and the like, where appropriate. The detector 111 in the CPU 11 provided in the information processing apparatus 10 then detects switching of an active input tool, as will be described later with reference to FIGS. 7-10.

The media reader 60 is configured to be mounted a recording medium RM. The media reader 60 is configured to be able to read information recorded in the recording medium RM that is mounted thereto. In this example, the recording medium RM is portable. The recording medium RM may be a computer readable recording medium, which is a flexible disk, a CD (e.g., a CD-ROM, a CD-R, a CD-RW), a DVD (e.g., a DVD-ROM, a DVD-RAM, a DVD-R, a DVD+R, a DVD-RW, a DVD+RW), a Blu Ray disk (e.g., BD-RE Ver. 1.0, BD-RE, BD-R, BD-ROM), Blu-ray3D, Ultra HD Blu-ray, a magnetic disk, an optical disk, an optical magnetic disk, a semiconductor memory, or the like, for example.

The storage device 50 is a well-known device that stores data in a readable and writeable manner, which is a hard disk drive (HDD) or a solid state drive (SSD), for example. In an example of the present embodiment, the storage device 50 functions as the first storage 51 and the second storage 52, as illustrated.

The first storage 51 stores object display format information 510.

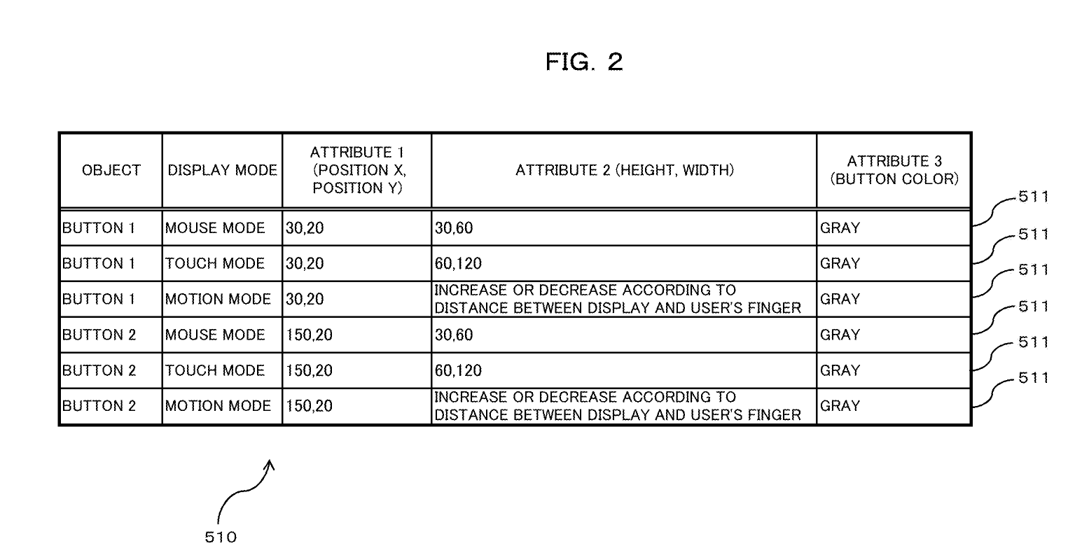

FIG. 2 is a diagram exemplifying display format information included in the object display format information, in the information processing apparatus as an example of an embodiment.

As depicted in FIG. 2, the object display format information 510 includes, for each object, multiple types of display format information 511 defining how that object is to be displayed.

A GUI application operating on the information processing apparatus 10 in an example of the present embodiment is configured from multiple GUI objects (hereinafter, simply referred to as “objects”). The display format of each object is switched to one of display formats for the three display modes: the mouse mode, the touch mode, and the motion mode, according to a status of an operation made by the user, for example. The mouse mode is the mode in which an object is being operated using the mouse 20, whereas the touch mode is the mode in which an object is being operated on the touch panel 40. The motion mode is the mode in which a finger or a thumb of the user moves in front of the touch panel 40, attempting to touch an object.

The display formats for each object in the respective display modes are defined as display format information 511. The display format information 511 is defined in advance for the respective display modes such that objects are appropriately displayed in each display mode, such as by changing the types, the shapes, and the positions of the objects, for example. For example, the display format information 511 is defined such that the normal sizes are used for objects upon a mouse operation (in the mouse mode). The display format information 511 is defined such that, when a finger or a thumb is brought closer to the touch panel 40 (in the motion mode), an object is displayed in an enlarged view when the distance between the finger or thumb and the touch panel 40 becomes smaller, according to the distance between the touch panel 40 and the user's finger or thumb. Further, the display format information 511 is defined such that the object is continued to be enlarged, upon touching the touch panel 40 (in the touch mode).

In the example depicted in FIG. 2, when “Button 1”, one of the objects, is in the “mouse mode”, Attribute 1 representing the display positions of the object on the display 40 (coordinates value on the display 40) is set to (position X, position Y)=(30, 20) (in the unit of pixel, for example). Attribute 2 representing the display size of the object is set to (height, width)=(30, 60) (in the unit of pixel, for example), and Attribute 3 representing the button color is set to “GRAY”. In this manner, Attributes 1-3 as display formats are defined for the mouse mode of “Button 1”.

In addition, respective Attributes 1-3 are similarly defined for the display modes of the “touch mode” and the “motion mode” of “Button 1”, as display formats for the object. Furthermore, respective Attributes 1-3 are defined for each display mode of “Button 2”, as display formats for the object.

Note that the object display format information 510 depicted in FIG. 2 may be defined in advance, upon the factory shipping of the information processing apparatus 10 or a display control program, or may be suitably defined by users. Furthermore, while the number of attributes included in each display format information 511 is three in the example depicted in FIG. 2, this is not limiting and the number of attributes may be two or less or may be four or more.

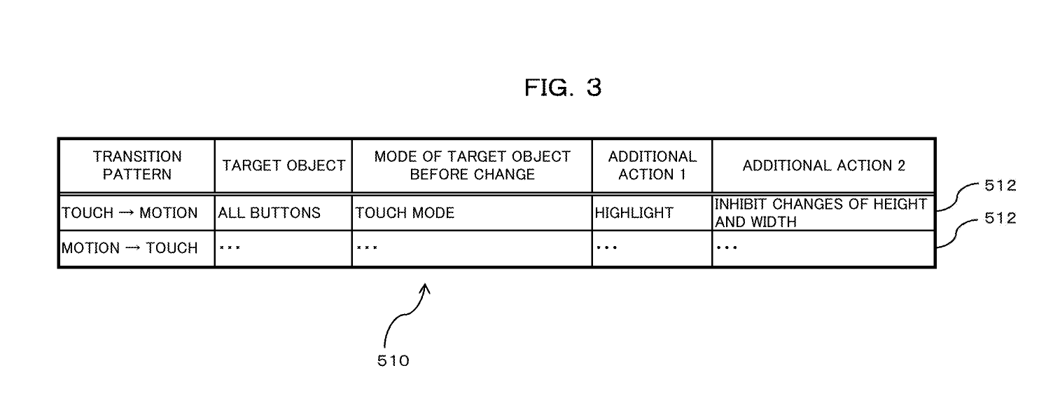

FIG. 3 is a diagram exemplifying transition pattern display format information included in the object display format information, in the information processing apparatus as an example of an embodiment.

The object display format information 510 includes multiple types of the transition pattern display format information 512. This means that the object display format information 510 includes display format information 511 depicted in FIG. 2 and transition pattern display format information 512 depicted in FIG. 3.

The transition pattern display format information 512 is information including display formats that are to be applied, when a particular transition history (transition pattern) is detected in a display mode in a target object, to that target object, preferentially to the display format information 511 depicted in FIG. 2, for that transition pattern.

In the example depicted in FIG. 3, when the modes of the object have been transitioned from the touch mode to the motion mode (i.e., the transition pattern of “touch->motion”), all buttons are highlighted (displayed in an emphasized view) as an additional action 1 and any changes in the height and the width of all buttons are inhibited as an additional action 2.

In the example depicted in FIG. 2, when the “Button 1” is in the “motion mode”, the display size of the object is increased or decreased according to the distance between the display 40 and a finger or thumb of a user, and the object becomes smaller as the user releases and brings his or her finger or thumb further from the display 40, for example. On the contrary, when a detector 111 (described later) detects that the mode is switched to the “motion mode” immediately after the “Button 1” is touched (selected) in the “touch mode”, an improved convenience is provided for the user by preventing any reduction in display size of the button. Hence, as exemplified in FIG. 3, by defining the transition pattern display format information 512, when the detector 111 (described later) detects that the mode is switched to the “motion mode” immediately after “Button 1” is touched in the “touch mode”, “Button 1” is highlighted and the size reduction of “Button 1” is inhibited.

When partially-matched transition patterns, e.g., partial matches with “mouse->motion” and “mouse->motion->touch”, are defined in the transition pattern display format information 512, applicable additional actions defined in the transition pattern display format information 512 may be applied to such partially-matched transition patterns all together. Alternatively, priorities among the transition patterns may be defined and additional actions for the transition pattern having the highest priority may be applied. While two additional actions are defined in each transition pattern display format information 512 in the example depicted in FIG. 2, this is not limiting and the number of additional actions may be one or may be three or more.

The second storage 52 stores the input history information 520.

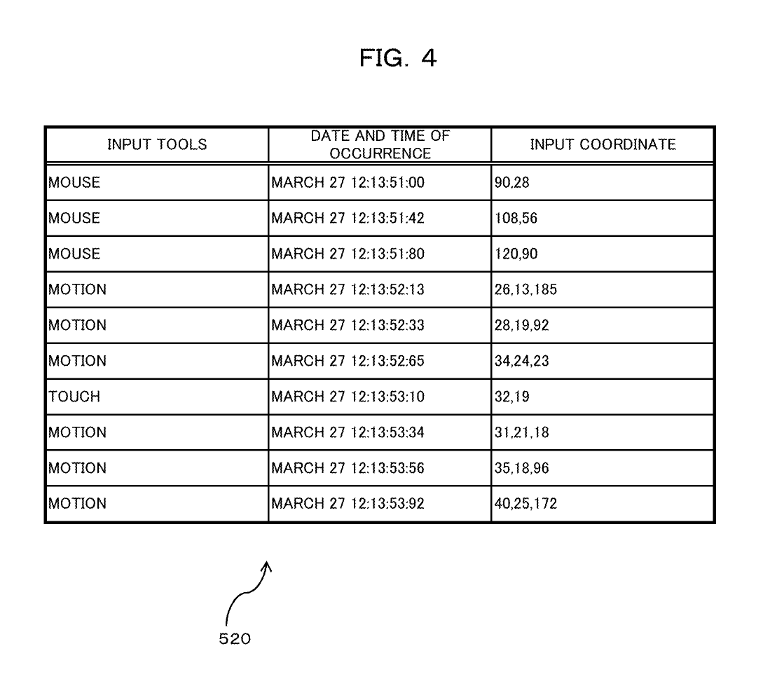

FIG. 4 is a diagram exemplifying input history information in the information processing apparatus as an example of an embodiment.

As depicted in FIG. 4, the input history information 520 includes information indicating which input tool was used, the date and time when the input occurred, and the coordinates of the input, which are related.

The example depicted in FIG. 4 indicates that an input was made with the “mouse” at the coordinates of (90, 28) at twelve o'clock 13 minutes 51 seconds 00 on March 27, an input was made with a “motion” at 52 seconds 13 at the coordinates of (26, 13, 185), and an input with a “touch” at 53 seconds 10 at the coordinates of (32, 19).

As described above, the input history information 520 stores input coordinates on the two axes of (X, Y), in the mouse mode and in the touch mode, and stores input coordinates on the three axes of (X, Y, Z), in the motion mode.

The input history information 520 also indicates information about transition histories of the input modes. In the example depicted in FIG. 4, the input modes have been transitioned from the mouse mode to the motion mode, then to the touch mode, and finally to the motion mode (“mouse->motion->touch->motion”).

Note that the input history information 520 may be updated at a certain time interval or may be updated every time the input coordinates move at a certain moving distance.

The information processing apparatus 10 is a personal computer (PC), a multifunctional mobile phone (smartphone), a tablet terminal, or a personal digital assistant (PDA), for example, which includes a central processing unit (CPU; computer) 11 and a memory 12, as depicted in FIG. 1.

The memory 12 is a storage device including a read only memory (ROM) and a random access memory (RAM). The ROM in the memory 12 stores a program written thereto, such as a basic input/output system (BIOS). The software program in the memory 12 is read and executed by the CPU 11, where appropriate. The RAM in the memory 12 is used as a primary storage memory or a working memory.

The CPU 11 is a processing apparatus that executes various types of controls and computations, and embodies various types of functions by executing the OS or a program stored in the memory 12. In other words, the CPU 11 functions as the detector 111 and the display controller 112, as depicted in FIG. 1.

Note that a program (display control program) for embodying the functions as the detector 111 and the display controller 112 is provided in the form of the one recorded on the aforementioned recording medium RM, for example. The computer reads the program from the recording medium RM via the media reader 60, and transfers it for storing in an internal storage device or an external storage device to use the program. Alternatively, the program may be recorded in a storage device (recording medium), e.g., a magnetic disk, an optical disk, or an optical magnetic disk, for example, and the program may be read from the storage device and is then supplied to the computer through a communication path.

Upon embodying the functions as the detector 111 and the display controller 112, the program stored in an internal storage device (the memory 12 in the present embodiment) is executed by a microprocessor (the CPU 11 in the present embodiment) in a computer. In this case, the computer may read and execute the program recorded in the recording medium.

The detector 111 detects a change of an active input tools. In other words, the detector 111 determines whether which input tool of the mouse 20, the motion sensor 30, or the touch panel 40, is currently used by the user, and detects a change of an active input tool.

The detector 111 determines that the pointing device input tool is being used as an active input tool when an input with the mouse 20, such as a movement of the pointer or a click, occurs. Alternatively, the detector 111 determines that the touch input tool is being used as an active input tool in response to a touch input, such as a tap, on the touch panel 40. Alternatively, the detector 111 determines that the motion input tool is being used as an active input tool when the motion sensor 30 detects an object.

Note that the detector 111 detects one of the display modes for each object at any time. The detector 111 may determine that an object on a GUI application is in the mouse mode but may also determine that another object is in the touch mode. In other words, each object assumes one of the modes independently from each other.

The detector 111 also causes information about the detected input tool to be stored in the second storage 52, as the input history information 520. The detector 111 then determines a transition pattern of the input tools, based on the input history information 520. Note that the input history information 520 may be updated by the detector 111 at a certain time interval or may be updated every time the input coordinates move at a certain moving distance. When the input history information 520 is updated by the detector 111 at a certain time interval, the detector 111 obtains coordinates values even when the mouse 20 or the motion sensor 30 or the touch panel 40 is not operated.

The display controller 112 causes an object to be displayed on the display 40. Specifically, the display controller 112 selects corresponding display format information 511 for an object according to a newly switched active input tool detected by the detector 111, and causes the object to be displayed using the selected display format information 511. In other words, the display controller 112 selects corresponding display format information 511 for the object, based on the input history information 520 stored in the second storage 52.

When a certain transition pattern of input tools is found in the input history information 520 by the detector 111, the display controller 112 selects corresponding transition pattern display format information 512 for that object based on the input history information 520. The display controller 112 then applies the transition pattern display format information 512 preferentially to the display format information 511.

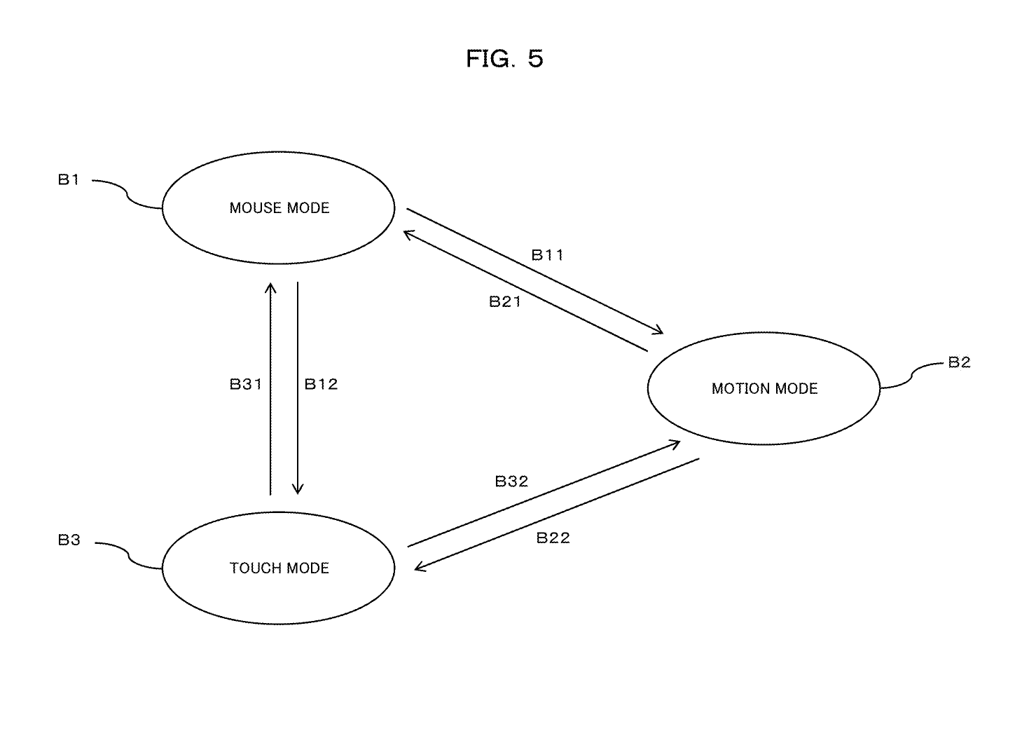

FIG. 5 is a diagram illustrating transitions among input mode states of GUI objects, in the information processing apparatus as an example of an embodiment.

As depicted in FIG. 5, the transitions among the above-described three input modes from each other, are allowed.

When the detector 111 detects a motion input in the mouse mode B1, the display controller 112 changes the input mode of a target object to the motion mode B2 (refer to the reference symbol B11).

When the detector 111 detects a touch input in the mouse mode B1, the display controller 112 changes the input mode of the target object to the touch mode B3 (refer to the reference symbol B12).

When the detector 111 detects a mouse input in the motion mode B2, the display controller 112 changes the input mode of the target object to the mouse mode B1 (refer to the reference symbol B21).

When the detector 111 detects a touch input in the motion mode B2, the display controller 112 changes the input mode of the target object to the touch mode B3 (refer to the reference symbol B22).

When the detector 111 detects a mouse input in the touch mode B3, the display controller 112 changes the input mode of the target object to the mouse mode B1 (refer to the reference symbol B31).

When the detector 111 detects a motion input in the touch mode B3, the display controller 112 changes the input mode of the target object to the motion mode B2 (refer to the reference symbol B32).

FIG. 6 is a diagram illustrating an exemplary display of GUI objects, in the information processing apparatus as an example of an embodiment.

In an example of the present embodiment, when a user is about to operate an object on a GUI application, the detector 111 determines which of the input tools, namely, the mouse, the touch, or the motion, is used by the user for the object that is being operated. The display controller 112 then switches the display mode to the display mode corresponding to the active input tool, for the object that is being operated. Specifically, when object is being operated using the mouse 20, the mouse mode is selected. When it is being operated on the touch panel 40, the touch mode is selected. When a finger or a thumb is approaching to the touch panel 40 for attempting to touch that object, the motion mode is selected.

In the example depicted in reference symbols A1-A8 in FIG. 6, the display controller 112 causes the window 400 having the “OK” and “Cancel” buttons as objects, to be displayed on the touch panel 40.

Initially, the “OK” and “Cancel” buttons as objects, as well as the pointer P, are displayed on the window 400 (refer to the reference symbol A1). Here, the user is operating the pointer P using the mouse 20. In other words, the detector 111 determines that the pointing device input tool is being used as an active input tool, and causes information indicating the input tool used, the date and time when the input occurred, and the coordinates of the input, to be stored in the second storage 52, by relating them, as the input history information 520. The display controller 112 then causes the target object “OK” button, to be displayed in the mouse mode, based on the object display format information 510. In the example depicted in Symbol A1 in FIG. 6, the display controller 112 also causes the “Cancel” button to be displayed in the mouse mode.

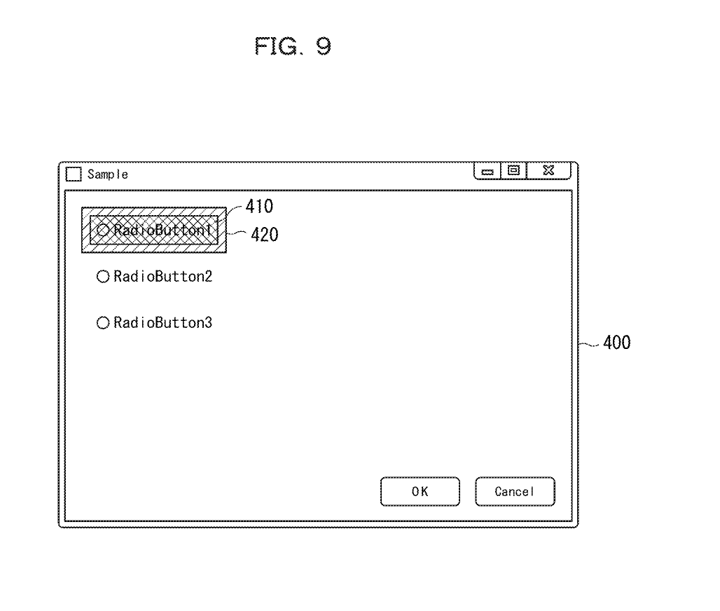

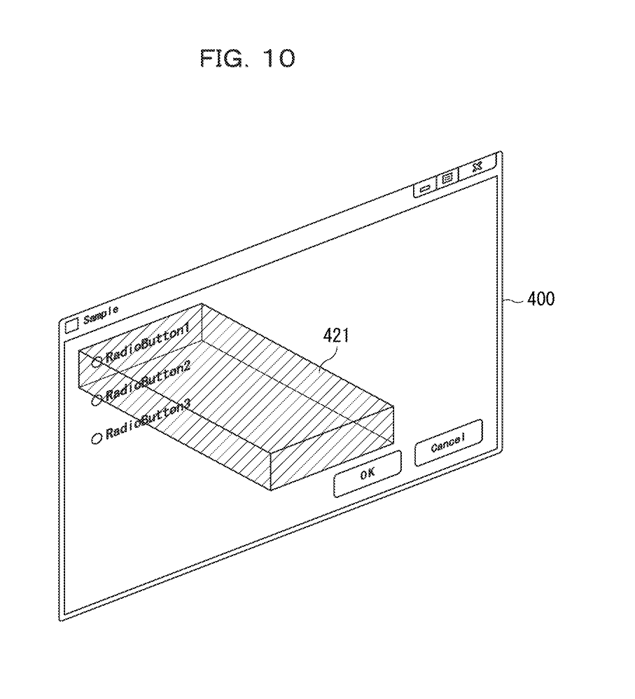

Here, when the user releases the mouse 20 and brings his or her finger or thumb closer to the touch panel 40 (refer to the reference symbol A2), the motion sensor 30 measures the distance between the user's finger/thumb F and the touch panel 40, and determines that the finger/thumb F is approaching to the “OK” button. The detector 111 determines that the motion input tool is being used as an active input tool, and causes information indicating the input tool used, the date and time when the input occurred, and the coordinates of the input, to be stored in the second storage 52, by relating them, as the input history information 520. In this case, the detector 111 also determines that the active input tool has been switched from the pointing device input tool to the motion input tool. The display controller 112 also causes the target object “OK” button, to be displayed in the motion mode, based on the object display format information 510. In an example of the display format information 511 depicted in FIG. 2, since the display size of an object in the motion mode is increased or decreased according to the distance between the display 40 and the finger/thumb F, the display controller 112 causes the “OK” button to be displayed in an enlarged view, in the example depicted in FIG. 6. Note that the determination of the target object by the detector 111 will be described later with reference to FIGS. 9 and 10.

When the user brings the finger/thumb F further closer to the “OK” button (refer to the reference symbol A3), the motion sensor 30 measures the distance between the user's finger/thumb F and the touch panel 40 and determines that the finger/thumb F is further approaching to the “OK” button. When the detector 111 determines that the motion input tool is being used as an active input tool, it causes information indicating the input tool used, the date and time when the input occurred, and the coordinates of the input, to be stored in the second storage 52, by relating them, as the input history information 520. The display controller 112 also continues to cause the target object “OK” button to be displayed in the motion mode, based on the object display format information 510. Since the finger/thumb F approaches further to the “OK” button in this example, the display controller 112 causes the “OK” button to be further enlarged.

When the user taps (selects) the “OK” button with a finger/thumb F (refer to the reference symbol A4), the touch panel 40 detects a touch input on the “OK” button. The detector 111 determines that the touch input tool is being used as an active input tool, and causes information indicating the input tool used, the date and time when the input occurred, and the coordinates of the input, to be stored in the second storage 52, by relating them, as the input history information 520. In this case, the detector 111 also determines that the active input tool has been switched from the motion input tool to the touch input tool. The display controller 112 also causes the target object “OK” button, to be displayed in the touch mode, based on the object display format information 510. In the example depicted in FIG. 6, the display controller 112 causes the “OK” button to be displayed in an emphasized view (refer to the cross-hatching).

When the user releases the finger/thumb F from the “OK” button (refer to the reference symbol A5), the motion sensor 30 measures the distance between the user's finger/thumb F and the touch panel 40, and determines that the finger/thumb F is released from the “OK” button. The detector 111 determines that the motion input tool is being used as an active input tool, and causes information indicating the input tool used, the date and time when the input occurred, and the coordinates of the input, to be stored in the second storage 52, by relating them, as the input history information 520. In this case, the detector 111 also determines that the active input tool has been switched from the touch input tool to the motion input tool. The display controller 112 also causes the target object “OK” button, to be displayed in the motion mode, based on the object display format information 510. An example of the transition pattern display format information 512 depicted in FIG. 3 is defined such that a target object is displayed in a highlighted view and any changes in the height and the width are inhibited when the input mode is transitioned from the touch mode to the motion mode. Also in the example depicted in FIG. 6, the display controller 112 causes the “OK” button to be displayed in the highlighted view (refer to the hatching), and causes the size of the “OK” button to be maintained. In other words, even when the finger/thumb F is released from the “OK” button, the display controller 112 does not cause the display size of the “OK” button to be reduced.

When the user brings the finger/thumb F further away from the “OK” button (refer to the reference symbol A6), the motion sensor 30 measures the distance between the user's finger/thumb F and the touch panel 40, and determines that the finger/thumb F is moved further away from the “OK” button. The detector 111 determines that the motion input tool is being used as an active input tool, and causes information indicating the input tool used, the date and time when the input occurred, and the coordinates of the input, to be stored in the second storage 52, by relating them, as the input history information 520. The display controller 112 also continues to cause the target object “OK” button to be displayed while causing its height or width to be maintained, according to the additional actions 1 and 2 in the transition pattern display format information 512, based on the object display format information 510. The display controller 112 further continues to cause the “OK” button to be displayed in the highlighted view (refer to the hatching), while causing the size of the “OK” button to be maintained.

When the user brings the finger/thumb F even further away from the “OK” button (refer to the reference symbol A7), the motion sensor 30 measures the distance between the user's finger/thumb F and the touch panel 40, and determines that the finger/thumb F is moved even further away from the “OK” button. The detector 111 determines that the motion input tool is being used as an active input tool, and causes information indicating the input tool used, the date and time when the input occurred, and the coordinates of the input, to be stored in the second storage 52, by relating them, as the input history information 520. The display controller 112 also continues to cause the target object “OK” button to be displayed while causing its height or width to be maintained, according to the additional actions 1 and 2 in the transition pattern display format information 512, based on the object display format information 510. Then, the display controller 112 eliminates the highlighting of the “OK” button, on the condition when the distance between the user's finger/thumb F and the touch panel 40 reaches a certain threshold or greater, for example.

The user operates the mouse 20 to bring the pointer P closer to the “OK” button (refer to the reference symbol A8). The detector 111 determines that the pointing device input tool is being used as an active input tool, and causes information indicating the input tool used, the date and time when the input occurred, and the coordinates of the input, to be stored in the second storage 52, by relating them, as the input history information 520. In this case, the detector 111 also determines that the active input tool has been switched from the motion input tool to the pointing device input tool. The display controller 112 also causes the target object “OK” button to be displayed in the mouse mode, based on the object display format information 510. In the example depicted in FIG. 6, the display controller 112 changes the size of the “OK” button back to the size illustrated in the reference symbol A1.

As described above, in the information processing apparatus 10 in an example of the present embodiment, types, shapes, positions, and actions of objects in a GUI application are switched in real time, according to the statuses of mouse operations, the statuses of touches on the touch panel 40, and the statuses of approaches of fingers or thumbs F to the touch panel 40 (an object).

FIG. 7 is a diagram illustrating an exemplary display of a GUI application, in the information process ing apparatus as an example of an embodiment.

As depicted in FIG. 7, the display controller 112 displays a window 400 on the touch panel 40 as a GUI application, for example. The window 400 exemplified in FIG. 7 includes, as objects, “RadioButton1”, “RadioButton2”, and “RadioButton3” radio buttons and “OK” and “Cancel” buttons.

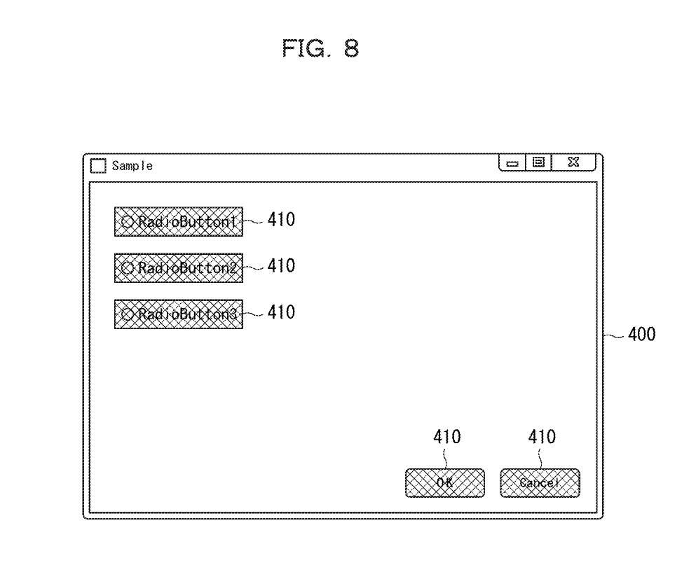

The window 400 illustrated in FIGS. 8-10, which will be referenced to later, has the similar configuration to that of the window 400 illustrated in FIG. 7.

FIG. 8 is a diagram illustrating hit regions in the GUI application, in the information processing apparatus as an example of an embodiment.

In FIG. 8, hit regions 410 for the objects present in the window 400 depicted in FIG. 7 are cross-hatched.

An invisible hit region 410 is defined for each object (refer to the cross-hatching). When a selection operation, e.g., a click or a tap, is made in any of the hit regions 410, it is determined that object corresponding to the hit region 410 is selected. For example, when the user uses the mouse 20 to click anywhere in the hit region 410 of the “RadioButton1”, the “RadioButton1” is selected.

While the hit regions 410 are rectangular in the example depicted in FIG. 8, this is not limiting and the hit regions 410 may have any shapes that coincide with shapes of objects, for example.

FIG. 9 is a diagram illustrating a mode change region in the GUI application in the mouse mode and in the touch mode, in the information processing apparatus as an example of an embodiment.

In the mouse mode and the touch mode, an invisible mode change region 420 is defined (refer to the hatching) for each object outside the hit region 410 (refer to the cross-hatching) of that object, so as to surround the hit region 410. The hit regions 410 and the mode change regions 420 of the objects other than the “RadioButton1” are omitted for the sake of brevity. When the pointer enters the mode change region 420 or a touch input is made within the mode change region 420, it is determined that the input tool used for the target object is a new active input tool. For example, when the user uses the mouse 20 to move the pointer from the outside of the mode change region 420 of the “RadioButton1” into the mode change region 420, the detector 111 detects the pointing device input tool as a new active input tool for the “RadioButton1”. The display controller 112 then causes the “RadioButton1” to be displayed in the mouse mode, based on the object display format information 510.

While the same mode change regions 420 are used both in the mouse mode and in the touch mode in the example depicted in FIG. 9, this is not limiting and different mode change regions 420 may be used for the mouse mode and for the touch mode. Alternatively, the entire window 400 may be used as a mode change region 420, and the display controller 112 may switch between display modes as long as the coordinates of a pointer or a touch input are within the window 400. While the mode change regions 420 are rectangular in the mouse mode and in the touch mode in the example depicted in FIG. 9, this is not limiting and the mode change regions 42 may have any shapes that coincide with shapes of objects, for example.

FIG. 10 is a diagram illustrating a mode change region in the GUI application in the motion mode, in the information processing apparatus as an example of an embodiment.

Since a motion input is an input made in the three-dimensional space, a mode change region 421 is provided as a three-dimensional volume (refer to the hatching), as depicted in FIG. 10. The mode change region 421 has a shape that is similar to that of the mode change region 420 depicted in FIG. 9, but protrudes vertically in a certain distance from the screen of the touch panel 40, for example. The mode change regions 421 of the objects other than the “RadioButton1” are omitted for the sake of brevity. For example, when a finger or thumb of a user enters the mode change region 421 of the “RadioButton1”, the detector 111 detects the motion input tool as an active input tool for the “RadioButton1”. The display controller 112 then causes the “RadioButton1” to be displayed in the motion mode, based on the object display format information 510.

While the mode change regions 421 have rectangular parallelepiped shapes in the motion mode in the example depicted in FIG. 10, this is not limiting and the mode change regions 421 may be a three-dimensional shape with curved surfaces, which coincide with shapes of objects, for example.

Information about the hit regions 410 and the mode change regions 420 and 421 depicted in FIGS. 8-10 are stored in the storage device 50, together with data on the window 400 and the objects thereon.

(B) Operations

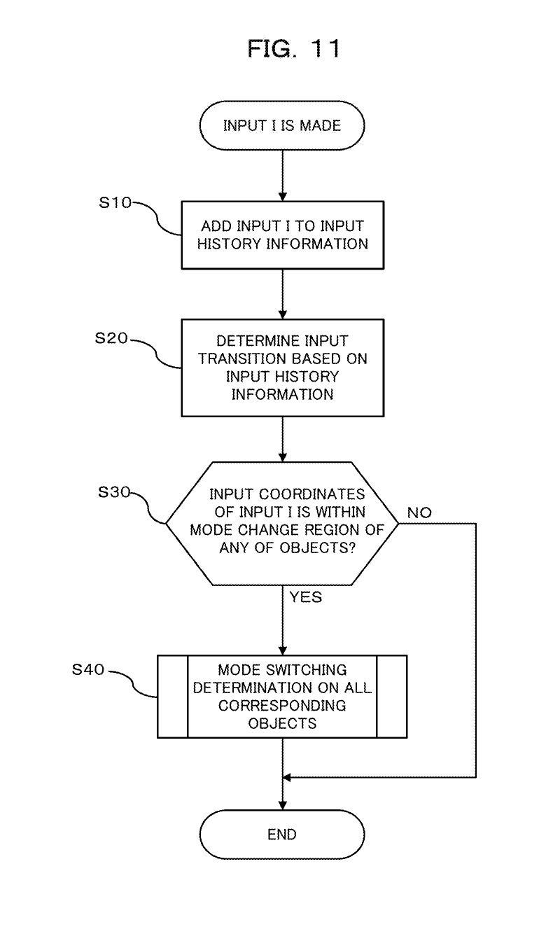

Input mode control processing in the information processing apparatus 10 as an example of an embodiment configured as described above, will be described with reference to a flowchart (Steps S10-S40) depicted in FIG. 11.

When an input I of the mouse 20, the touch panel 40, or the motion sensor 30 is generated while a GUI application is activated so as to be capable of receiving operations from a user, the detector 111 adds the input I to input history information 520 (Step S10). Specifically, the detector 111 causes information indicating the input tool used, the date and time when the input occurred, and the coordinates of the input for the input I, to be stored in the second storage 52, by relating them, as the input history information 520.

The detector 111 determines the transition history (pattern) of the input tools, based on the input history information 520 (Step S20). In other words, the detector 111 detects a change of an input tool.

The detector 111 determines whether the input coordinates of the input I are within mode change regions 420 and 421 of any of objects (Step S30).

When the input coordinates of the input I are not within the mode change regions 420 and 421 of any of the objects (refer to the NO route from Step S30), the input mode control processing is terminated.

When the input coordinates of the input I are within the mode change regions 420 and 421 of any of objects (refer to the YES route from Step S30), the display controller 112 executes a mode switching determination on all of the corresponding objects (Step S40), and then terminates the input mode control processing.

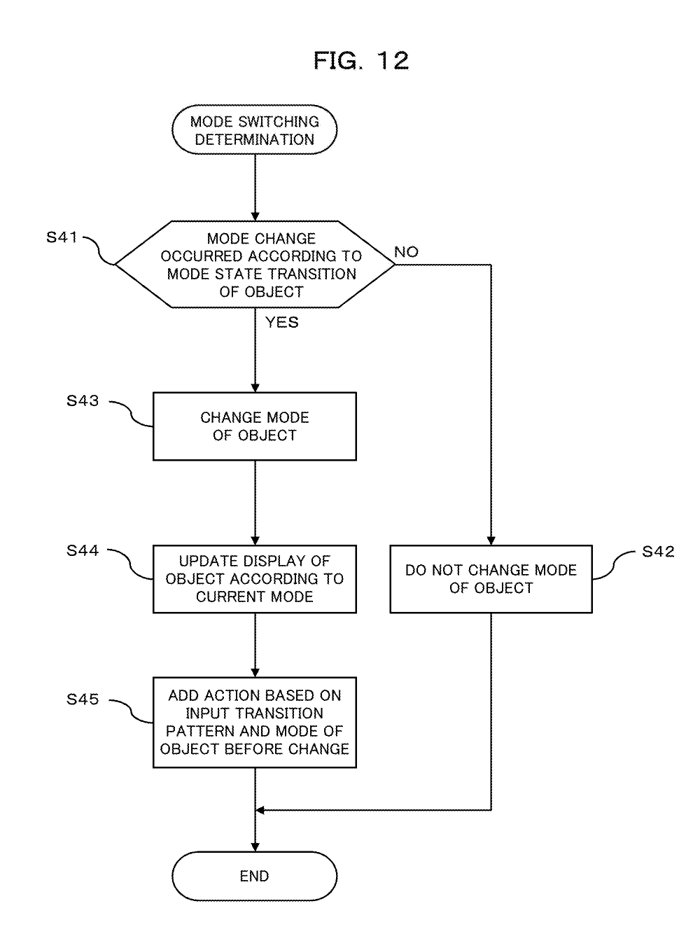

Next, mode switching determination processing in the information processing apparatus 10 as an example of an embodiment, will be described with reference to a flowchart (Steps S41-S45) depicted in FIG. 12.

Stated differently, the details of the mode switching determination processing in Step S40 depicted in FIG. 11 will be described.

The display controller 112 determines whether the display mode change occurs so as to coincide with any of the defined mode status transitions for the object (Step S41).

When no display mode change occurs so as to coincide with any of the defined mode status transitions for the object (refer to the NO route from Step S41), the display controller 112 terminates the input mode switching processing, without changing the display of the object mode (Step S42). For example, when the new input I in Step S10 in FIG. 11 was made with the mouse 20 and the input immediately before the input I in the input history information 520 was also made with the mouse 20, the flow moves to this Step S42 and the input mode switching processing is then terminated.

When the display mode change occurs so as to coincide with any of the defined mode status transitions for the object (refer to the YES route from Step S41), the display controller 112 changes the display of the object mode (Step S43). For example, the new input I in Step S10 in FIG. 11 was made with the motion sensor 30 and the input immediately before the input I in the input history information 520 was made with the mouse 20, the flow moves to this Step S43 and the input mode switching processing is terminated.

The display controller 112 updates the display of the object according to the current display mode (Step S44).

The display controller 112 adds an action based on the transition pattern and the display mode before the change of the object (Step S45), and then terminates the input mode switching processing.

(C) Advantageous Effects

As described above, in accordance with the information processing apparatus 10 in an example of the present embodiment, the detector 111 detects a change between the input tools, and the display controller 112 selects the display format information 511 for that GUI object, according to the active input tool after the detected change. Thus, display modes of GUI objects appropriate for active input tools can be immediately applied even when a user is operating the GUI application, and the user can make reliably operations, regardless of which input tool the user is using and how the user is using the GUI application. Furthermore, effective input operations can be provided even when the input tools are changed.

When a certain transition pattern (history) of input tools is found in the input history information 520, the display controller 112 selects corresponding transition pattern display format information 512 for the GUI object, based on the input history information 520. This allows further actions to be added to a target object, based on the transition pattern and the input mode prior to the mode change of the object, and enables an optimal display of the GUI object using the transition pattern of the input tools. For example, when the transition pattern from the touch mode to the motion mode (“touch->motion”) is found in any of transition patterns in input history information 520, the display controller 112 does not change the size of the target object, thereby providing minute controls on objects.

When the detector 111 detects a switch to the motion input tool 30, the display controller 112 causes the GUI object to be displayed in an enlarged or reduced view, according to the distance between the touch panel 40 and a finger or a thumb of a user, etc., based on display format information. This allows the user to confirm which GUI object the user is about to operate, before making a touch operation, and allows the target GUI object to be displayed in an optimal manner.

(D) Miscellaneous

The disclosed technique is not limited to the embodiment described above, and the present embodiment may be practiced in various modifications in the extent not departing from the spirit thereof. The configurations and steps in the present embodiment may be omitted or selected where appropriate, or may be suitably combined.

The disclosure of the present embodiments enables those skilled art to embody and manufacture an information processing apparatus, a di splay control program, and a display control method of the present embodiments.

In accordance with the disclosed information processing apparatus, effective input operations can be provided even when input tools are changed.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a plurality of input tools;
a first storage that stores pieces of object display format information, the pieces of object display format information relating pieces of display format information in a plurality of types to a graphical user interface (GUI) object;
a detector that detects a change of an input tool of the input tools; and
a display controller that selects a corresponding piece of object display format information for the GUI object according to the input tool after the detected change, and causes the GUI object to be displayed using the selected object display format information.

2. The information processing apparatus according to claim 1, further comprising a second storage that stores input history information indicating histories of inputs made through the plurality of input tools,
wherein the detector causes information related to the detected input tool, to be stored into the second storage, as the input history information, and
the display controller selects the corresponding piece of object display format information for the GUI object, based on the input history information.

3. The information processing apparatus according to claim 2, wherein the pieces of object display format information include pieces of transition pattern display format information in a plurality of types, and
the display controller selects a corresponding piece of transition pattern display format information for the GUI object based on the input history information, when a transition pattern for a certain input tool is present in the input history information.

4. The information processing apparatus according to claim 3, wherein the plurality of input tools comprise at least two of:
a pointing device input tool that is used for operating the GUI object with a pointing device;
a touch input tool that is used for operating the GUI object in response to a touch input; and
a motion input tool that is used for operating the GUI object in response to an action made by a user.

5. The information processing apparatus according to claim 4, wherein the display controller causes the GUI object selected by the touch input tool, to be displayed in an emphasized view, when a transition from the touch input tool to the motion input tool is present in the input history information, as the transition pattern.

6. The information processing apparatus according to claim 4, wherein the display controller causes the GUI object to be displayed in an enlarged or reduced view according to a distance between a screen of the information processing apparatus and the user, based on the transition pattern display format information, when the detector detects a change to the motion input tool.

7. The information processing apparatus according to claim 4, wherein the display controller causes the GUI object to be displayed in the enlarged view based on the transition pattern di splay format information, when the detector detects a change to the touch input tool.

8. A computer-readable recording medium storing a display control program, the display control program causing a computer provided in an information processing apparatus comprising a plurality of input tools, to execute processing for:
detecting a change of an input tool of the input tools; and
selecting, from pieces of object display format information stored in a first storage, the pieces of display format information relating pieces of display format information in a plurality of types to a graphical user interface (GUI) object, a corresponding piece of object display format information for the GUI object according to the input tool after the detected change, and causing the GUI object to be displayed using the selected object display format information.

9. The computer-readable recording medium storing the display control program according to claim 8, wherein the display control program causes the computer to execute processing for:
causing information related to the detected input tool, to be stored into a second storage that stores input history information indicating histories of inputs made through the plurality of input tools, as the input history information; and
selecting the corresponding piece of object display format information for the GUI object, based on the input history information.

10. The computer-readable recording medium storing the display control program according to claim 9, wherein the pieces of object display format information include pieces of transition pattern display format information in a plurality of types, and
the display control program causes the computer to execute processing for selecting a corresponding piece of transition pattern display format information for the GUI object based on the input history information, when a transition pattern for a certain input tool is present in the input history information.

11. The computer-readable recording medium storing the display control program according to claim 10, wherein the plurality of input tools comprise at least two of:
a pointing device input tool that is used for operating the GUI object with a pointing device;
a touch input tool that is used for operating the GUI object in response to a touch input; and
a motion input tool that is used for operating the GUI object in response to an action made by a user.

12. The computer-readable recording medium storing the display control program according to claim 11, wherein the display control program causes the computer to execute processing for:
causing the GUI object selected by the touch input tool, to be displayed in an emphasized view, when a transition from the touch input tool to the motion input tool is present in the input history information, as the transition pattern.

13. The computer-readable recording medium storing the display control program according to claim 11, wherein the display control program causes the computer to execute processing for:
causing the GUI object to be displayed in an enlarged or reduced view according to a distance between a screen of the information processing apparatus and the user, based on the transition pattern display format information, when a change to the motion input tool is detected.

14. The computer-readable recording medium storing the display control program according to claim 11, wherein the display control program causes the computer to execute processing for:
causing the GUI object to be displayed in the enlarged view based on the transition pattern display format information, when a change to the touch input tool is detected.

15. A display control method in an information processing apparatus comprising a plurality of input tools, the display control method comprising:
detecting a change of an input tool of the input tools; and
selecting, from pieces of object display format information stored in a first storage, the pieces of object display format information relating pieces of display format information in a plurality of types to a graphical user interface (GUI) object, a corresponding piece of object display format information for the GUI object according to the input tool after the detected change, and causing the GUI object to be displayed using the selected object display format information.

16. The display control method according to claim 15, comprising:
causing information related to the detected input tool, to be stored into a second storage that stores input history information indicating histories of inputs made through the plurality of input tools, as the input history information; and
selecting the corresponding piece of object display format information for the GUI object, based on the input history information.

17. The display control method according to claim 16, wherein the pieces of object display format information include pieces of transition pattern display format information in a plurality of types, and
the display control method further comprising selecting a corresponding piece of transition pattern display format information for the GUI object based on the input history information, when a transition pattern for a certain input tool is present in the input history information.

18. The display control method according to claim 17, wherein the plurality of input tools comprise at least two of:
a pointing device input tool that is used for operating the GUI object with a pointing device;
a touch input tool that is used for operating the GUI object in response to a touch input; and
a motion input tool that is used for operating the GUI object in response to an action made by a user.

19. The display control method according to claim 18, comprising:
causing the GUI object selected by the touch input tool, to be displayed in an emphasized view, when a transition from the touch input tool to the motion input tool is present in the input history information, as the transition pattern.

20. The display control method according to claim 18, comprising:
causing the GUI object to be displayed in an enlarged or reduced view according to a distance between a screen of the information processing apparatus and the user, based on the transition pattern display format information, when a change to the motion input tool is detected.
